(19) United States
(12) Patent Application Publication
(10) Pub. No.: US 2026/0244851 A1
(43) Pub. Date: Aug. 20, 2026

(54) CHECK SHEET GENERATION SYSTEM

(71) Applicant: Hitachi, Ltd., Tokyo (JP)

(72) Inventors: Shingo HAYASHI, Tokyo (JP); Shoji YAMAMOTO, Tokyo (JP); Masahiko NIIOKA, Tokyo (JP); Tomoki TACHIKAWA, Tokyo (JP)

(21) Appl. No.: 19/295,086

(22) Filed: Aug. 8, 2025

(30) Foreign Application Priority Data
Feb. 19, 2025 (JP) 2025-024751

(51) Int. Cl. G06F 40/18; G06F 16/957

(52) U.S. Cl. CPC G06F 40/18; G06F 16/9577

(57) ABSTRACT

Provided is a technique that allows a user to easily convert a check sheet generated by table calculation software to a check sheet with a form even when the user does not have expertise. A check sheet generation system according to the present invention generates a web screen for form information registration by extracting layout information from a first check sheet in a first data format, and generates a second check sheet with a form in a second data format based on layout information and form information.

### CROSS-REFERENCE TO RELATED APPLICATION

This application claims the priority of Japanese Patent Application No. 2025-024751 filed on Feb. 19, 2025, which is incorporated herein by reference in its entirety.

### BACKGROUND

The present invention relates a technique for generating a check sheet that a worker uses in work site.

In the social infrastructure project supported by large manual works, a shortage of skilled workers is becoming serious due to declining birth rate and aging population that are accelerated recently. Accordingly, the enhancement of work efficiency is indispensable to continuously maintain the quality of a product. In view of such circumstances, on a manufacture site, to reduce a burden on each worker by improving work efficiency, automation of compilation work where a simple routine work is repeated has been attracting attention. In the conventional work, a worker records work information on a check sheet made of paper on a site, then, after returning to an office, the worker performs a compilation work by manually transcribing the work information to software for compilation. The transcribing by manual inputting is likely to cause a human error, and the manual inputting is repeated a considerable number of times and hence, a large burden is imposed on the worker. In this manner, although a demand for improving efficiency of a work by automating a compilation work is large, there exists a drawback that it is difficult to accurately extract handwritten information recorded on paper as digital information.

Japanese Unexamined Patent Application Publication No. 2012-146008 describes a method of automating a compilation work of a check sheet prepared by table calculation software. Japanese Unexamined Patent Application Publication No. 2012-146008 discloses a technique where “A gateway device 1 acquires layout information, character information in a cell, and input form information having identification information from table calculation data, and generates style definition data indicating a layout of Hyper Text Markup Language (HTML) and HTML structure definition data indicating the structure of HTML, and outputs these data. A web application server displays the acquired HTML data on a client terminal, and receives input information from an input form, transmits the input information to the gateway device 1 together with the identification information, and generates an achievement registration logs for respective users. The gateway device 1 newly generates filled-out table calculation data having input information from the received input information (see Abstract).”

### SUMMARY

Japanese Unexamined Patent Application Publication No. 2012-146008 discloses a technique where table calculation data is directly compiled by table calculation software, form information are registered in cells in a sheet, table calculation data registered in form information is uploaded to a server thus generating an HTML with a form. By allowing a worker to perform an operation by replacing a check sheet made of paper with an HTML with a form, work information in the check sheet can be accurately extracted as digital information. However, in Japanese Unexamined Patent Application Publication No. 2012-146008, as pre-processing for generating an HTML with a form, it is necessary to describe form information in cells using a markup language. Accordingly, it is necessary for a user to memorize a special coding rule and, at the same time, there arises a drawback that a worker cannot determine a kind of form that is generated at a glance even when the worker watches the cells in the sheet at the time of editing.

The present invention has been made in view of the above-mentioned drawbacks, and it is an object of the present invention to provide a technique that can simply convert a check sheet that table calculation software generates into a check sheet with a form even when a worker has no expertise.

A check sheet generation system according to the present invention generates a web screen for form information registration by extracting layout information from a first check sheet in a first data format, and generates a check sheet with a form in second data format based on the layout information and form information.

According to the check sheet generation system of the present invention, anyone can easily convert a check sheet generated by table calculation software to a check sheet with a form. Objects, configurations and advantageous effects other than the above will become apparent from the description of the embodiment made hereinafter.

### BRIEF DESCRIPTION OF THE DRAWINGS

FIG. 1 is a view describing a method of generating a check sheet with a form based on a table calculation data that table calculation software generates.

FIG. 2 is a view illustrating one example of a case where table calculation data is converted into an HTML using a function of the table calculation software.

FIG. 3 is a view illustrating an example of a method of registering form information using a web screen for form information registration.

FIG. 4 is a view illustrating an example of a method of simulating an operation of the check sheet with a form on a web screen.

FIG. 5 is a constitutional view of a check sheet generation system 500 according to a first embodiment.

FIG. 6 is a flowchart illustrating an operation of the check sheet generation system 500.

FIG. 7 is a view illustrating a flow that depicts a cell region 700 on the web screen for form information registration.

FIG. 8 is a constitutional view of the check sheet generation system 500 according to a second embodiment.

FIG. 9A is a view illustrating one example of a web screen 900 for form information registration before layout information is extracted from a first check sheet in a first data format.

FIG. 9B is a view illustrating one example of a second check sheet with a form generated by the configuration of the first embodiment.

FIG. 10 is a constitutional view of the check sheet generation system 500 according to a third embodiment.

FIG. 11 is a view illustrating a method of generating a text box in a date format.

FIG. 12 is a view illustrating a web screen for form information registration by which a form of a designated format can be simply generated.

FIG. 13 is a view illustrating one example of a check sheet 1300 that is used in an inspection of a product on a manufacture site.

FIG. 14 is a view illustrating a web screen for form information registration that can generate a check sheet that enhances work efficiency.

FIG. 15A is a view illustrating a general data structure of a PDF.

FIG. 15B is a view illustrating a data structure 1503 of the PDF to which a unique property is added.

FIG. 16 is a view illustrating one example of a PDF where a layout is broken.

FIG. 17 is a view illustrating one example of a PDF where displacement is generated between a size and a position of a form.

FIG. 18 is a view illustrating one example of a case where characters in a form cannot be seen because some characters are outside the form.

FIG. 19 is a constitutional view of the check sheet generation system 500 according to a sixth embodiment.

FIG. 20 is a view describing a method of calculating printing magnification that suppresses an unintended margin.

FIG. 21 is a view illustrating one example of a PDF to which special characters are added.

FIG. 22 is a graph illustrating a relationship between a printing magnification and a displacement amount of a size.

FIG. 23A is a graph illustrating a relationship between the number of rows and size of a form.

FIG. 23B is a graph where a relationship between a character size and size of a form per a unit row is plotted based on the characteristic illustrated in FIG. 23A.

FIG. 24 is a flowchart illustrating the manner of operation of the check sheet generation system 500 according to the sixth embodiment.

### FIRST EMBODIMENT

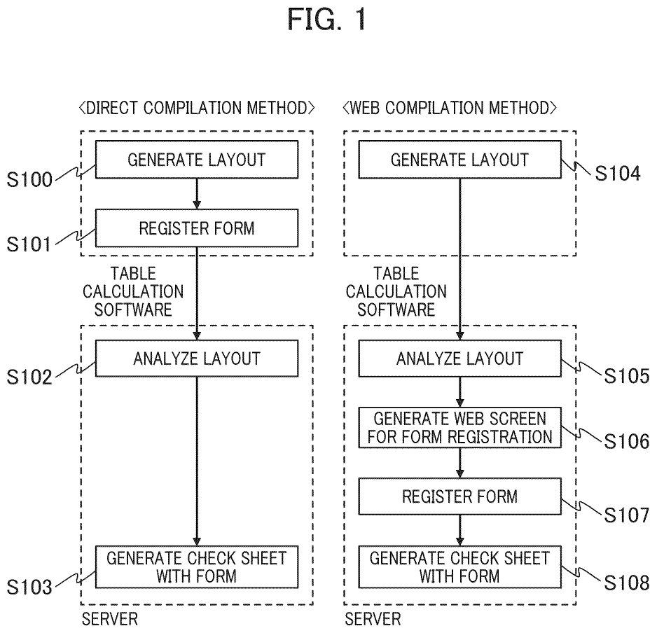

FIG. 1 is a view describing a method of generating a check sheet with a form based on a table calculation data that table calculation software generates. As the method of generating a check sheet with a form based on table calculation data, a direct compilation method where table calculation software directly edits table calculation data and registers form information, and a web compilation method where form information is registered on a web screen are named.

Before describing these methods, first, a data format of a check sheet is described. In general, a check sheet is generated in the form of table calculation data or document data using table calculation software or document generation software. The data format of the check sheet generated firstly is referred to as a first data format. Table calculation data or document data that is generated using the table calculation software, the document generation software or the like is generated estimating a case where the software is operated on a general-use computer such as a desktop computer. Accordingly, there may be a case where it is not suitable to display the data on a portable terminal. For example, as such a case, a case is considered where table calculation data or document data is generated in a data format that browsing software implemented on the portable terminal cannot process. In such a case, it is necessary to convert the check sheet generated in the first data format into a data format that enables the display of the check sheet on the portable terminal. The data format after conversion is referred to as a second data format.

Next, the direct compilation method is described. A worker generates a layout of a check sheet in the first data format using table calculation software (S100). The table calculation data has a cell region partitioned in a grid shape, and can compile characters, the positions of the characters in the cells, sizes and colors of the cells and the like using the table calculation software. Next, the worker registers form information in the cells in the sheet as character information, and uploads the table calculation data registered in the form information to a server (S101). Next, the server analyzes layout information of the received table calculation data (S102), and generates a check sheet with a form based on the analyzed layout information (S103).

Next, the web compilation method is described. The worker generates a layout of a check sheet in a first data format using the table calculation software (S104), and uploads the table calculation data on the server. Next, the server analyzes the layout information of the received table calculation data (S105), and generates a web screen for form information registration based on the analyzed layout information (S106). On this web screen, the cell region that is partitioned in a grid shape based on the layout information generated in S104 exists, and form information of a form to be generated can be registered in each cell (S107). The registration of the form information may be performed by additional uploading of file data in a text format or the like in which form information is described, the registration on a web screen by a user operation or the like. The specific method of registering the form information on the web screen by a user operation is described later. Next, the server generates a check sheet with a form based on the layout information and the form information (S108). To compare with a direct compilation method where table calculation data is directly compiled using the table calculation software and the form information is registered, the web compilation method differs from the direct compilation method with respect to a point that a web screen for form information registration is newly generated and the form information is registered on the web screen.

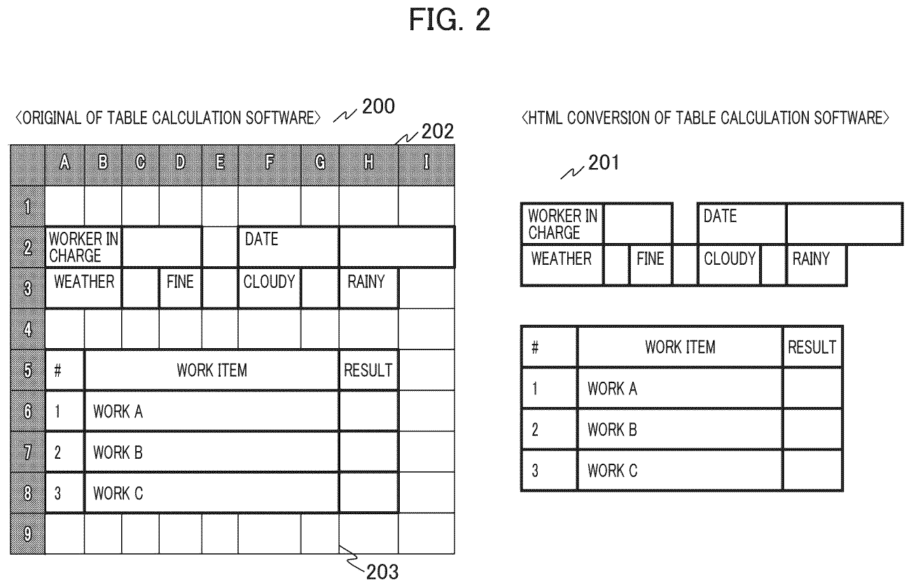

FIG. 2 illustrates one example of a case where table calculation data is converted into an HTML using a function of the table calculation software. The table calculation software includes a function of converting an output format to the HTML. By applying the HTML conversion to a manipulation screen 200 of the table calculation software, an HTML 201 is generated. Here, a case is considered where the HTML 201 is used as a web screen for form information registration. For example, when a worker uploads the table calculation data on the manipulation screen 200 to the server, the HTML 201 is displayed as a web screen for form information registration. In this HTML 201, neither information 202 indicating the number of a matrix nor non-set ruled lines information 203 exist. In a case where a new tool is introduced to realize business digitalization, when a manipulation screen of the new tool largely differs from a manipulation screen of software with which a worker is used to use, a psychological burden on a user is increased. Further, the HTML 201 that can be generated by a conversion function is a static content and hence, an interactive user interface where cells are selected and form information is registered in the selected cell does not exist. To provide an interactive user interface, it is necessary to incorporate a JavaScript into the HTML 201 or to newly implement a web screen by using a JavaScript library.

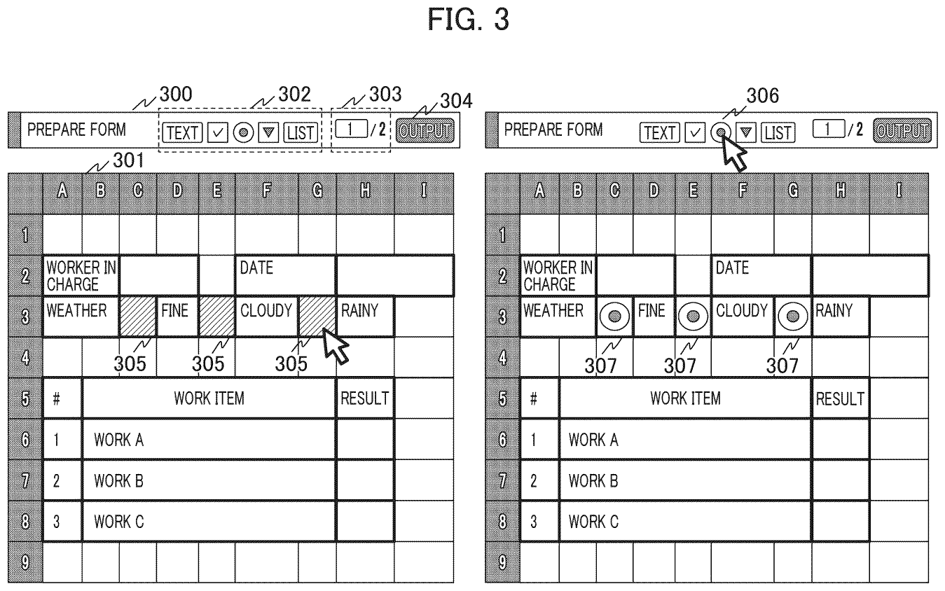

FIG. 3 is a view illustrating an example of a method of registering form information using a web screen for form information registration. On the web screen, a tool bar 300 and a display region 301 of a table calculation data exist. The tool bar 300 includes an icon region 302 that designates kinds of forms, a display region 303 of a page number, and a button 304 that outputs a check sheet with a form. In the display region 301, the cell regions that are partitioned in a grid shape based on layout information of table calculation data are generated. As an example of registering form information, a case where radio button is generated in a column of weather is considered. The user selects a cell 305 in which the user wants to dispose a radio button, and clicks an icon 306 of the radio button in the tool bar 300. When the icon 306 of the radio button is clicked, an icon 307 of the radio button is generated in the cell 305 in a selected state, and form information is registered.

As has been described above, by registering form information using a user interface in a selection format, the worker can simply register the form information even when the worker does not have expertise. By displaying an icon that corresponds to form information registered in the cell where the form information is registered, a user can determine a kind of the generated form at a glance. When the generated icon is excessively large, the icon sticks out from the cell, while when the generated icon is excessively small, the icon cannot be visually recognized. Accordingly, it is preferred that the icon has a size to an extent that the icon is fitted into one cell. By arranging the tool bar 300 and the display region 301 in the same screen, a user can reduce the number of times of click manipulation and hence, the ease-to-use of the user interface can be enhanced. By forming the display region 301 into the cell region partitioned in a grid shape, the difference in external appearance between the manipulation screen of the new tool and the manipulation screen of the table calculation software with which the user is used to use can be suppressed and hence, a psychological burden on a user who uses the new tool can be reduced. Accordingly, in this embodiment, attributes of an input form and the like are compiled on the web screen, this compilation is reflected on a check sheet on the web screen (web check sheet) and, at the same time, PDF data having the same input form can be generated.

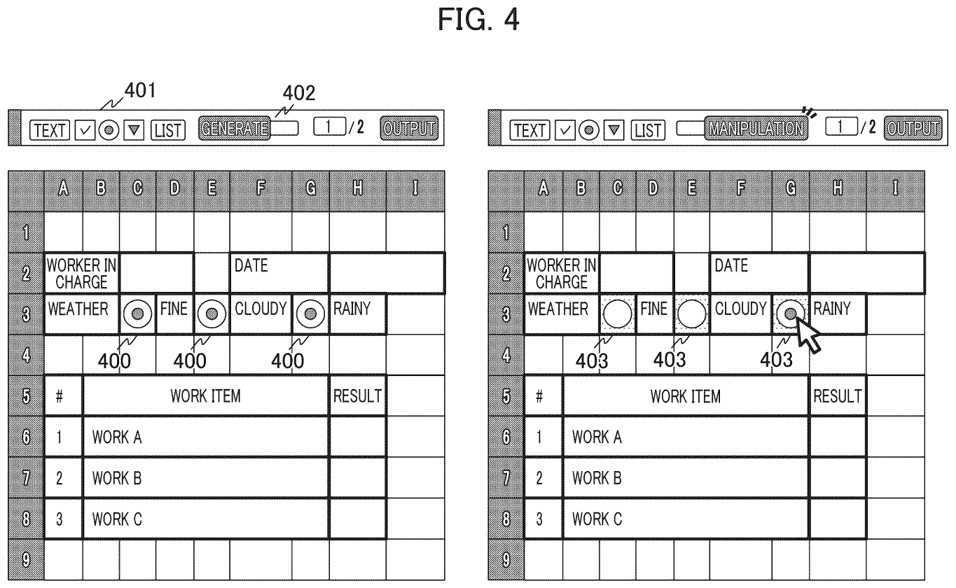

FIG. 4 is a view illustrating an example of a method of simulating an operation of the check sheet with a form on a web screen. An icon 400 corresponding to registered form information is displayed in a cell and hence, a user can determine a kind of generated form at a glance. However, the icon 400 is not a component into which information can be inputted and hence, the ease-to-use of a check sheet with a form cannot be confirmed by a user manipulation on the web screen. Accordingly, a display mode changeover switch 402 that can change over a display mode is added to a tool bar 401 (form kind designation unit). The display mode has a generation mode and a manipulation mode, and the display mode can be changed over by clicking the display mode changeover switch 402. For example, when the display mode is changed over to the manipulation mode, the icon 400 is changed over to a form 403 that allows inputting of information, and the user can confirm the operation by the click manipulation.

Then, a case is considered where the registered form information is changed or erased. In a case a user changes form information, the user selects a cell in which the user wants to change the form information, and selects an icon designating a type of the form from the tool bar 401. In a case where the user wants to erase the form information, the user selects the cell in which the user wants to erase the form information, and presses an erasing button on the keyboard. In performing these manipulations, it is preferred that a selection state of the cell is indicated to a user by coloring the selected cell. However, when a form that allows inputting of information is generated as in the case of a manipulation mode, it is difficult to determine whether the cell is selected or the operation is confirmed on a system side. For example, when a JavaScript where a pop-up is displayed when selected is incorporated into the form, the pop-up is displayed each time the cell in which the user wants to change or erase form information is selected and hence, the ease-to-use is worsened.

As an example, a case is considered where a user attempts to select a cell C4 in FIG. 4. Although the user wants to select the cell C4, when the cell C4 is clicked, a radio button component in the same cell reacts thus giving rise to a possibility that the cell itself cannot be selected. Accordingly, in this embodiment, a display mode where only the arrangement of an input form is visually grasped, and a manipulation mode where operation of the input form is confirmed can be changed over so that only an icon image of the input form is arranged in the display mode.

As described above, the check sheet generation system includes the display mode where a kind of a form is displayed by an icon and the manipulation mode that performs the displaying in a form that allows inputting of information, and the check sheet generation system is configured to change over these modes. Accordingly, form information can be registered without causing an erroneous operation in a JavaScript or the like and hence, an operation of the check sheet can be confirmed on a web screen.

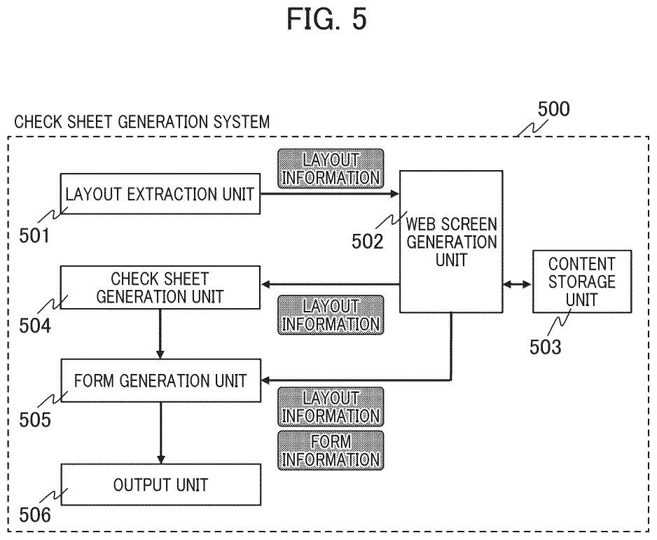

FIG. 5 is a constitutional view of the check sheet generation system 500 according to the first embodiment of the present invention. The check sheet generation system 500 includes a layout extraction unit 501, a web screen generation unit 502, a content storage unit 503, a check sheet generation unit 504, a form generation unit 505, and an output unit 506.

The layout extraction unit 501 extracts layout information (information such as cell sizes, coupled cells, ruled lines, and characters) from a first check sheet in a first data format, and transmits the layout information to the web screen generation unit 502. The web screen generation unit 502 generates a web screen having a cell region partitioned in a grid shape based on received layout information. The content storage unit 503 stores the layout information and the form information of the respective cells in the cell region. The check sheet generation unit 504 generates a second check sheet in a second data format based on layout information that the content storage unit 503 stores. The form generation unit 505 generates a form in the second check sheet that the check sheet generation unit 504 generates based on the layout information and the form information that the content storage unit 503 stores. The output unit 506 outputs a second check sheet with a form that the form generation unit 505 generates.

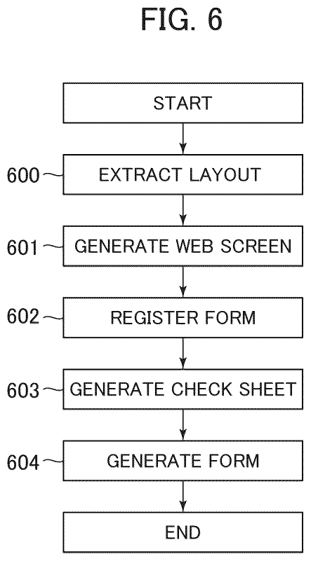

FIG. 6 is a flowchart illustrating an operation of the check sheet generation system 500. First, from the first check sheet in a first data format, layout information such as information on the cell sizes, coupled cells, ruled lines, and characters is extracted (S600). Next, a web screen for form information registration that includes the cell region partitioned in a grid shape is generated based on the extracted layout information (S601), and form information of the respective cells are registered on the web screen (S602). Next, a second check sheet in a second data format is generated based on the layout information (S603), a form is generated in the second check sheet generated based on the layout information and the form information (S604), and is outputted as the second check sheet with a form (S604).

### FIRST EMBODIMENT: SUMMARY

The check sheet generation system 500 according to the first embodiment generates the web screen for form information registration by analyzing the layout information of the first check sheet in a first data format, and generates the second check sheet in a second data format based on the layout information and the form information. A user can register the form information by only performing a click manipulation that designates a kind of form and hence, the user can simply change the first check sheet to the second check sheet with a form even when the user does not have expertise.

### SECOND EMBODIMENT

In the second embodiment of the present invention, a configurational example that realizes re-rendering of a web screen for form information registration at a low cost is described. Other configurations are substantially equal to the configurations described in the above-mentioned embodiment.

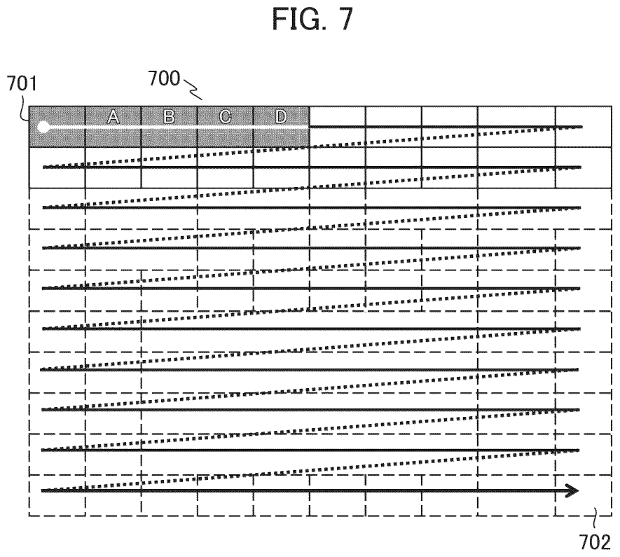

FIG. 7 is a view illustrating a flow that depicts a cell region 700 on the web screen for form information registration. On the web screen for form information registration, in drawing the cell region 700, the cells are drawn while scanning in a row direction using a left upper cell as a start point 701 and using a right lower cell as an end point 702. In this embodiment, a case is considered where the cell region 700 is implemented on a component base using a JavaScript library. When the cell region 700 is implemented on a component base, each time a state of cells is changed, re-rendering on the cell region 700 is generated. The cell region 700 illustrated in FIG. 7 is constituted of 100 components in total (10 rows and 10 columns). In case of a check sheet having a large number of work items, re-rendering is performed each time states of several hundred components are changed. Time necessary for re-rendering is increased proportional to the number of components. Accordingly, when re-rendering occurs each time a change of state occurs, a manipulation ability of a user is impaired.

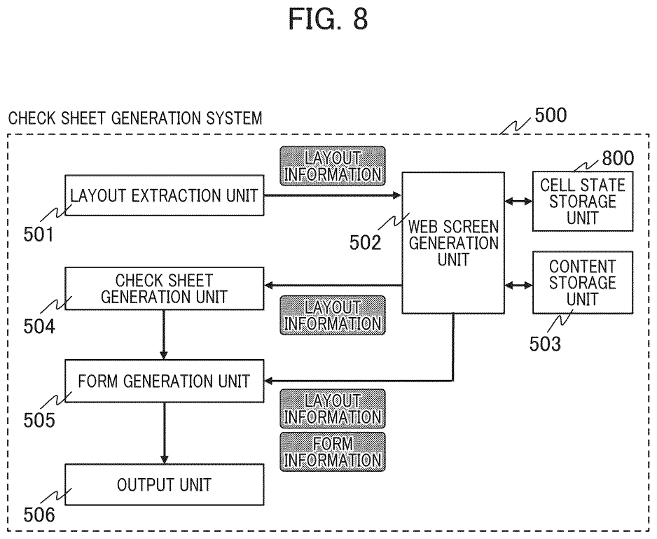

FIG. 8 is a constitutional view of the check sheet generation system 500 according to the second embodiment. The check sheet generation system 500 according to the second embodiment includes a cell state storage unit 800 in addition to the configuration described in the above-mentioned embodiment. The cell state storage unit 800 stores states of respective cells in the cell region that the web screen generation unit 502 generates. The web screen generation unit 502, when a change in a state of components in the web screen is detected, compares states of the components in the web screen and states of the respective cells stored in the cell state storage unit 800, and redraws only the cells that exhibit a change in state. With such processing, the cells which do not exhibit a change in state are not redrawn and hence, re-rendering can be realized at a low cost.

On the premise that only updated cells are redrawn, it is desirable that each cell is constituted as one software component respectively. Accordingly, each cell can be treated as one independent component object and hence, redrawing can be easily performed individually. A software framework that treats each cell as one component is known and hence, the description of such processing is omitted.

### SECOND EMBODIMENT: SUMMARY

The check sheet generation system 500 according to the second embodiment includes the cell state storage unit 800 that stores the states of the respective cells in the cell region in the web screen for form information registration. When the web screen generation unit 502 detects a change in state of the components in the web screen, the web screen generation unit compares the components in the web screen and the state of the respective cells stored in the cell state storage unit 800, and redraws only the cells where a change in state exists. Accordingly, a cost of re-rendering can be suppressed, and manipulation ability of a user is enhanced.

### THIRD EMBODIMENT

In the third embodiment of the present invention, a constitutional example that generates a web screen for form information registration based on a second check sheet with a form is described. Other configurations are substantially equal to the configurations described in the above-mentioned embodiment.

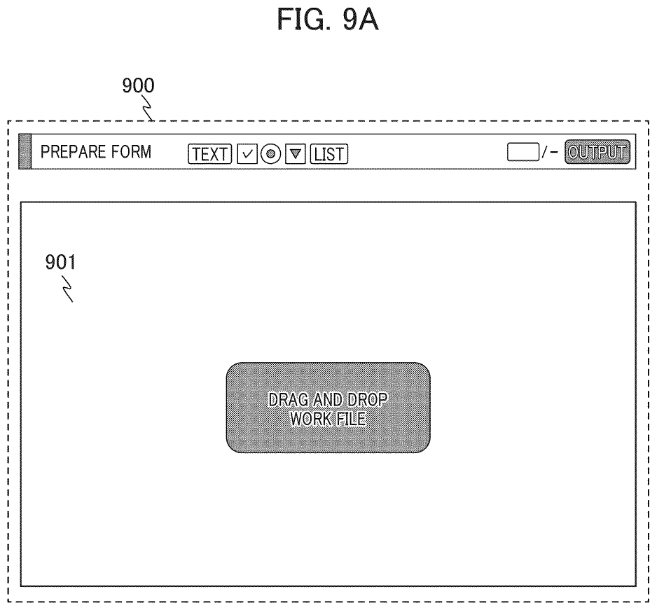

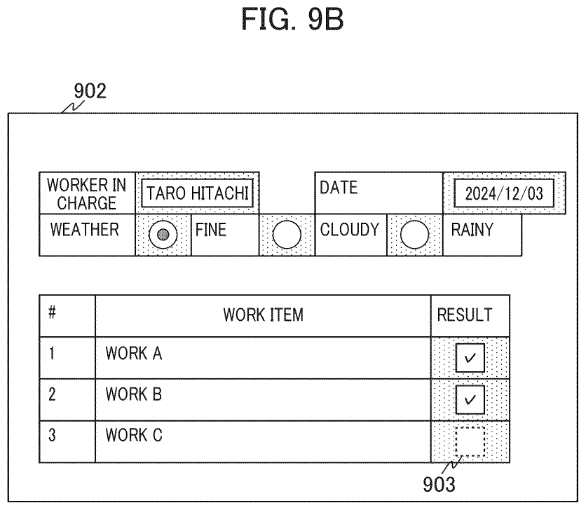

FIG. 9A is an example of the web screen 900 for form information registration before layout information is extracted from a first check sheet in a first data format. When a user drags and drops the first check sheet in the first data format into a cell region 901, the cell region 901 is generated based on layout information of the first check sheet.

FIG. 9B illustrates one example of a second check sheet with a form generated in accordance with the constitution of the first embodiment. In the third embodiment, a case is considered where the provision of a form 903 of check box type to the second check sheet 902 with a form is forgotten. To regenerate the second check sheet with a form, a user drags and drops a first check sheet in a first data format into the cell region 901. The first check sheet does not contain form information and hence, it is necessary for a user to register form information from the beginning.

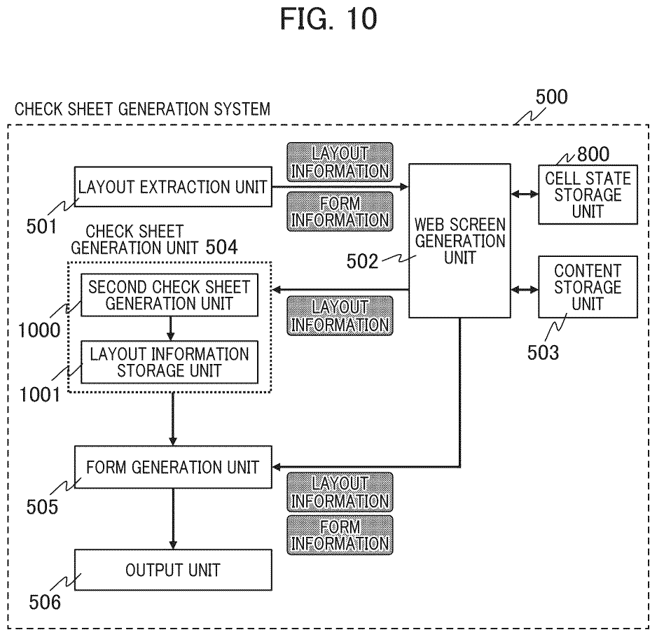

FIG. 10 is a configurational view of the check sheet generation system 500 according to the third embodiment. The check sheet generation system 500 according to the third embodiment differs from the configurations of the embodiments described heretofore with respect to a portion of the configuration of the check sheet generation unit 504. The check sheet generation unit 504 includes, in addition to a function of generating a second check sheet described in the first embodiment (second check sheet generation unit 1000), a layout information recording unit 1001 that records layout information. The layout information recording unit 1001 records layout information that the content storage unit 503 stores in internal data of the second check sheet that the second check sheet generation unit 1000 has generated. The data structure of the second check sheet is described later.

As has been described above, by imparting the layout information to the second check sheet, it is possible to extract both the layout information and the form information from the second check sheet by the layout extraction unit 501. By generating a web screen for form information registration using the extracted layout information and the extracted form information, even in a case where the provision of a form is forgotten, it is possible to resume the registration of the form information from the middle. Further, the web screen for form information registration can be generated from the second check sheet and hence, it is unnecessary to manage the first check sheet as an original.

### THIRD EMBODIMENT: SUMMARY

The check sheet generation system 500 according to the third embodiment includes a layout information recording unit that records layout information in internal data of a generated second check sheet. With such a configuration, both the layout information and the form information can be extracted from the second check sheet. Accordingly, by extracting the layout information and the form information from the second check sheet and by generating a web screen for form information registration using the extracted layout information and the extracted form information, the registration of the form information can be resumed from the middle.

### FOURTH EMBODIMENT

In a fourth embodiment of the present invention, the description is made with respect to a configuration example that can easily generate a form that receives only imputing of a designated format. Other configurations are substantially equal to the configurations described in the above-mentioned embodiment.

On a check sheet at a manufacturing site, input columns in which a date of business, a time of work, and measured values measured by a detection instrument are recorded exist. An input format of these input columns is decided in advance and hence, by restricting the input format such that, for example, a date column receives only inputting of a date format, a time column receives only inputting of a time format, and a column of measured values receives only inputting of valid numerals of designated digits, human errors can be prevented. In this embodiment, as an example of a method of designating the input format, the description is made with respect to a method of generating a text box of a date format.

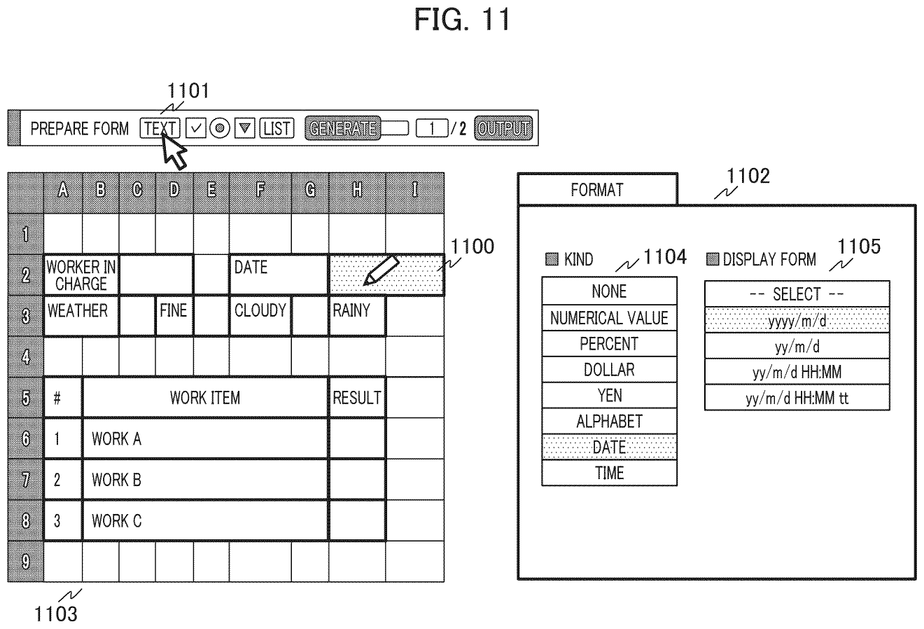

FIG. 11 is a method of generating a text box in a date format. In this method, a case is considered where a text box in a date format is generated in a H2 cell. A user selects a cell 1100 having the cell number H2 and then, clicks a text generation icon 1101. When the text generation icon 1101 is clicked, form information is registered, and an icon indicating the text box is displayed in the cell 1100. In a case where the cell 1100 is in a selected state, a property setting screen 1102 of the form is displayed on the same screen as a display region 1103 of the cell. The property setting screen 1102 of the form is provided with items that set a kind 1104 and a display format 1105 of the input format. A text box in a date format can be generated by selecting a date from the kind 1104 in the property setting screen 1102 and by designating a display format in the display format 1105. In this method, it is necessary to perform a click manipulation two times to designate the input format. The input columns such as date, time and numerical values are used on the check sheet on a manufacturing site highly frequently and hence, the manipulation to designate the input format is cumbersome. In addition, there exists a problem that a kind of the input format cannot be determined based on the icon displayed in the display region 1103 of the cell.

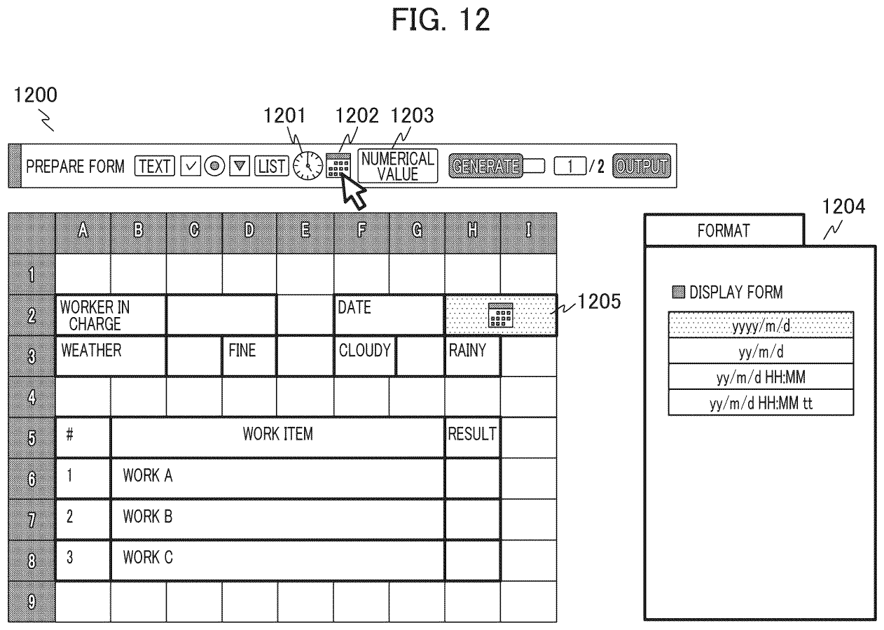

FIG. 12 is a web screen for form information registration that can easily generate a form in a designated format. A web screen 1200 according to the fourth embodiment includes, in addition to the configuration described in the embodiments described above, a time form generation icon 1201, a date form generation icon 1202, and a numerical value form generation icon 1203. The input formats of the forms generated by these icons are set to time, date and numerical values respectively in advance. On a property setting screen 1204, the display format can be set in case of the time and the date, and an effective numerical value can be set in case of the numerical values. In many cases, these set values use unique values. Accordingly, it is preferable to set default values in advance as indicated on the property setting screen 1204. In this embodiment, the case is exemplified where the form in the date format is registered in a cell 1205 of the cell number H2. By changing a kind of an icon that is displayed in the cell corresponding to a kind of an input format, a user can determine the kind of the input format at a glance.

### FOURTH EMBODIMENT: SUMMARY

The web screen for form information registration according to the fourth embodiment includes the form generation-use icon in which an input format is set. Even in the case of using the forms of the same kind, by distinguishing the form generation-use icons corresponding to the respective input formats, time and efforts for changing the properties can be omitted. Further, by distinguishing the icons generated in the cells corresponding to the kinds of input formats, a user can determine the kind of the generated form including the kind of the input format at a glance.

### FIFTH EMBODIMENT

In a fifth embodiment of the present invention, the description is made with respect to a configurational example that can generate a check sheet with improved work efficiency. Other configurations are substantially equal to the configurations described in the above-mentioned embodiment.

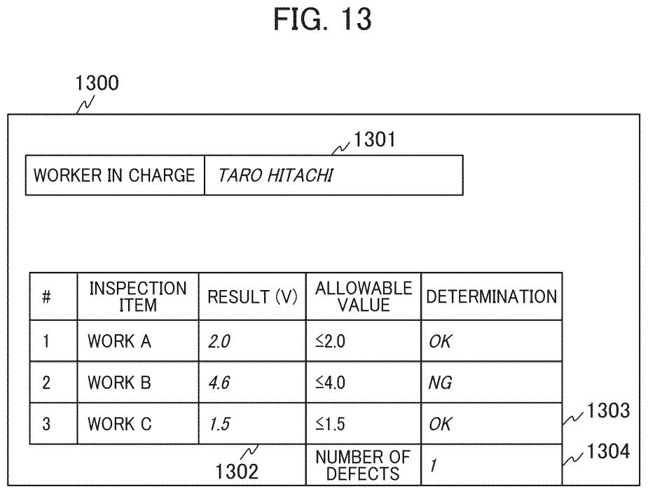

FIG. 13 is an example of a check sheet 1300 that is used in an inspection of products in a manufacturing site. In the manufacturing site, an inspection work is performed so as to record a state of products as a numerical value using a measurement equipment. A worker fills out his/her name in a column for describing a person in charge 1301, and records an inspection result in a result column 1302. In the check sheet 1300, three inspection items exist. However, in a check sheet that is used in an actual work, a large number of inspection items exist. Accordingly, there is a need to record an inspection result quickly by hand writing. Further, in the inspection work, there exists a column 1303 where the determination result is recorded after it is determined whether or not a measurement result is within an allowable value. In the inspection work there also exists a column 1304 where the number of abnormalities are recorded after the abnormalities are collected. Conventionally, these works are performed visually and hence, a human error is liable to occur and a burden is imposed on a worker. Accordingly, there has been a need to automate these works.

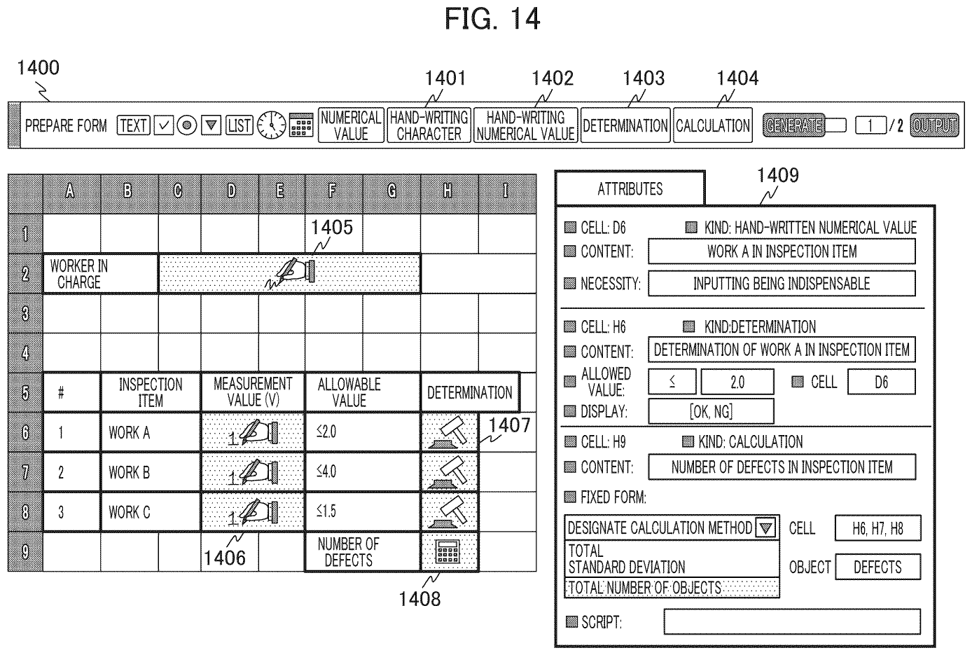

FIG. 14 is a view illustrating a web screen for form information registration that can form a check sheet that enhances work efficiency. A web screen 1400 according to the fifth embodiment includes, in addition to the configuration described in the embodiments described above, a hand-writing character filling column generation icon 1401, a hand-writing numerical value filling column generation icon 1402, a determination column generation icon 1403, and a calculation column generation icon 1404. When form information is registered by using these generation icons, a hand-writing character filling icon 1405, a hand-writing numerical value filling icon 1406, a determination icon 1407, and a calculation icon 1408 are generated, respectively. Attributes relating to these icons can be set by using a property setting screen 1409.

First, the description is made with respect to set values on a property setting screen in the hand-writing character filling column and the hand-writing numerical value filling column. The attributes consisting of work contents and necessity or non-unnecessity of inputting can be set in the hand-writing character and hand-writing numerical values. By setting these attributes, a rate (progress rate) of the number of inputted items to the number of all items to be inputted as data at the time of collecting work information can be automatically calculated. These attributes can be also set in a general form such as a textbox or a check box.

Next, the description is made with respect to set values on the property setting screen in a determination column. As attributes of the determination columns, the content of the determination, the allowability of the determination, objects of determination and the display content after the determination can be set. In the property setting screen 1409, in a case where the cell of the cell number D6 is 2.0 or less, the set value is set such that OK is displayed in the cell of the cell number H6.

Next, the attribute setting in the calculation column is described. With respect to the attributes in the calculation column, the content of calculation, a fixed form and JavaScript can be set. In the fixed form, a calculation method, a cell range and a calculation object can be set. In the property setting screen 1409, the set values are set such that the number of cells that contain defects in the cell numbers H6, H7, H8 are displayed in the cell of the cell number H9. In case of a complicated calculation formula that cannot be expressed by a fixed form, JavaScript is set in a Script column.

Next, the form generated by such setting is described. A textbox is generated in a determination column and a calculation column, and a condition formula based on the set values are incorporated into the textbox as JavaScript. In the hand-writing character filling column and the hand-writing numerical value filling column, a read-only textbox having a unique property indicating a hand-writing region is generated. In this read-only textbox, an analysis result of hand-written data is recorded as character information. Accordingly, even the hand-written data is also handled as data by JavaScript in the determination column and the calculation column.

Next, the description is made with respect to a method recognizing hand-written data corresponding to the hand-writing column as a character. To recognize hand-written data corresponding to the hand-writing column as the character, it is necessary to specify a region in the hand-writing column and to perform processing to analyze the hand-written data in the region. To be more specific, a form having a unique property indicating a hand-writing region is extracted, a region of the hand-writing column is specified based on a position and a size of the extracted form and hand-written data in the region is recognized as a character using a deep learning model. In this embodiment, the description has been made by taking the character recognition that uses a deep learning model as an example. However, when the deep learning model is generated with a small calculation resource, there is a problem that the accuracy of recognition of the hand-written character is low. Particularly, in a check sheet on a manufacturing site, there exist a large number of columns in which measurement values are filled and hence, there is a demand for a method that can recognize the hand-written numerical values with high accuracy. Accordingly, for example, an on-line hand-written character recognition model is applied to the hand-writing numerical value filling column. The on-line hand-written character recognition model is a machine learning model that learns hand-written stroke data. By limiting kinds of characters to be learned to numerical values, the numerical values can be recognized with high accuracy even with respect to a model generated by a small amount of calculation resource.

As described above, it is sufficient for the form that is generated in the hand-written character filling column to store a result of analysis processing and hence, a non-display attribute textbox may be used as the form. In case of the non-display attribute textbox, a user cannot visually determine the presence or absence of the form and hence, it is desirable to color a frame of the non-display attribute textbox using a rectangular annotation.

As a technique for implementing the hand-writing recognition, an arbitrary known technique can be used and hence, the description of such a technique is omitted. The respective attributes indicated on a right side in FIG. 14 can be written in attributes such as meta data that the PDF data possesses, for example. However, the respective attributes are not limited to such attributes. Arithmetic operation processing such as calculation processing and determination processing can be implemented by a script that is operated on a PDF or the like, for example. However, the arithmetic operation processing is not limited to such processing.

### FIFTH EMBODIMENT: SUMMARY

The web screen for form information registration according to the fifth embodiment has a function of registering the form that enables automatic determination and automatic calculation based on the hand-written character filling column and the input result. The fifth embodiment can cope with the hand-writing and hence, a recording time can be shortened, and the determination and the calculation implemented visually can be automated. Accordingly, the occurrence of human errors can be prevented.

### SIXTH EMBODIMENT

In a sixth embodiment of the present invention, the description is made with respect to a configurational example where, in a second check sheet in a second data format that the check sheet generation system 500 generates, positions and sizes of objects in the second check sheet are corrected. In the sixth embodiment, a portable document format (PDF) format is estimated as the second data format. Other configurations are substantially equal to the configurations described in the above-mentioned embodiment.

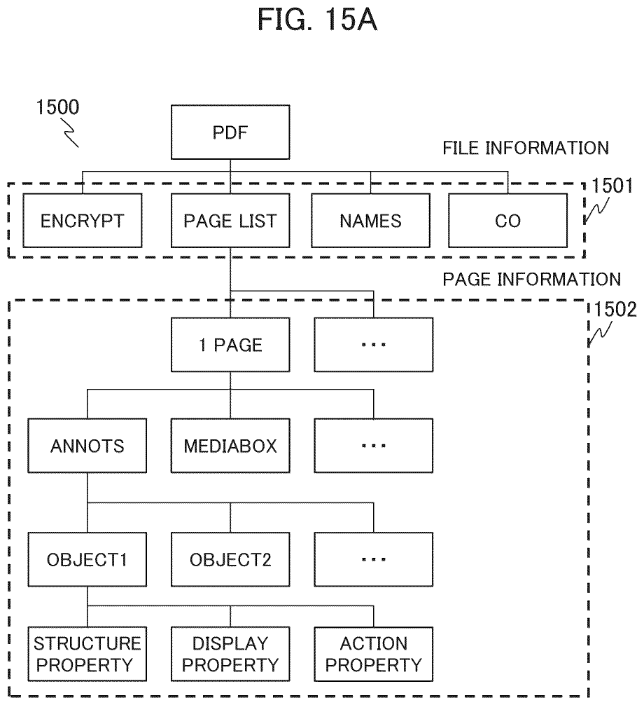

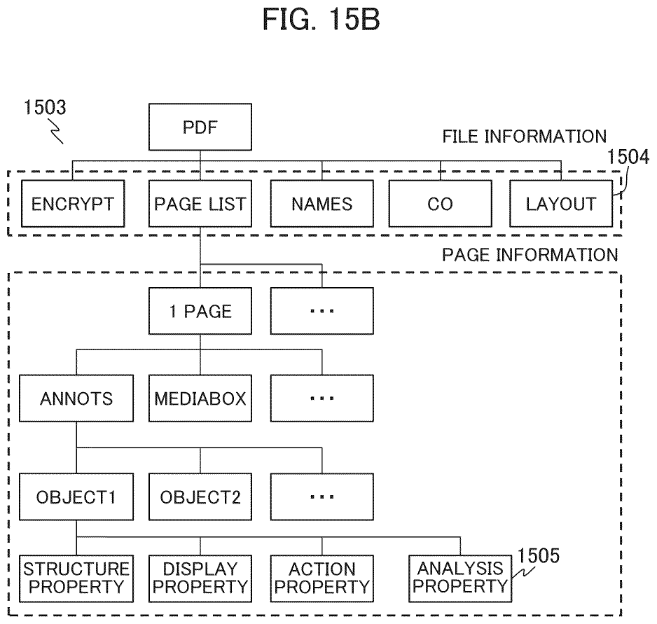

FIG. 15A illustrates the general data structure of the PDF. A general data structure 1500 of the PDF can be classified into file information 1501 and page information 1502. The data structure 1500 includes, as main objects, Encrypt that indicates property of locking for editing, Page list that forms page information as a list, Names that set access authorities from other files, and CO that implements a calculation script written in JavaScript. The page information 1502 includes a Mediabox that indicates page sizes of respective pages, and Annots in which property information for respective objects are collected.

FIG. 15B indicates the data structure 1503 of the PDF to which unique properties are added. The data structure 1503 of the PDF includes, in addition to the configuration of the general data structure 1500, layout information 1504 and an analysis property 1505. In the layout information 1504 and the analysis property 1505, the layout information and the attribute information described in the above-mentioned embodiments respectively are recorded. By adding such unique properties to the PDF, a web screen for form registration can be generated based on the PDF, and the work information after the collection can be easily analyzed.

Here, a method of generating a PDF based on layout information is considered. As illustrated in FIG. 15A and FIG. 15B, the PDF has a complicated data structure and hence, it is difficult to describe the data structure from zero. Accordingly, a method that uses free-of-charge software is considered. Amongst free-of-charge software, there exists a free-of-charge software that has: a function of generating table calculation data; and a function of converting table calculation data into a PDF. By making use of the free-of-charge software having these functions, table calculation data is generated based on layout information, then, the generated table calculation data is converted into a PDF thus easily generating the PDF. However, when a PDF is generated by making use of such a free-of-charge software, a case may occur where a problem that a layout is broken or the size or the position of a form is displaced.

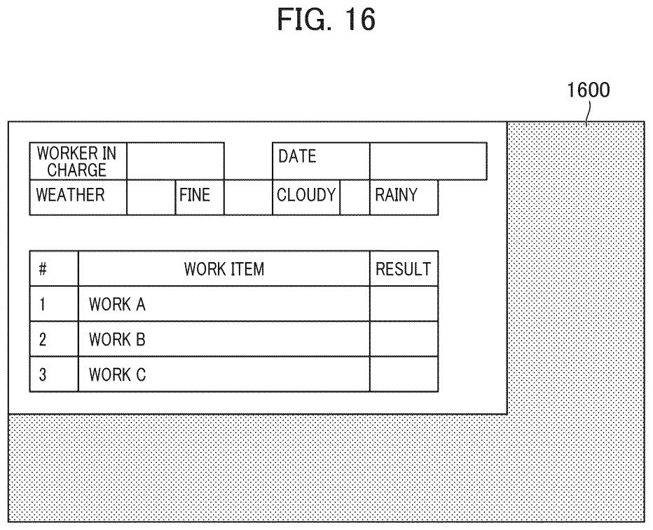

FIG. 16 is an example of a PDF where the layout is broken. When the table calculation data is converted into a PDF by making use of free-of-charge software, there may be a case where an unintended margin 1600 is generated. The generation of this unintended margin 1600 is caused by a difference in handling of coordinate systems between respective display modes of the table calculation software. In the table calculation software, a plurality of display modes such as standard mode and layout mode exist. For example, after the size of a cell is set to 2 pt in a standard mode, the display mode is changed to a layout mode, the size of the cell becomes 1.76 pt. On the other hand, after the size of a cell is set to 1.76 pt in a layout mode, the display mode is changed to a standard mode, the size of the cell becomes 1.88 pt. The relationship of coordinate systems between the respective display modes is irreversible. Although the relationship of coordinates systems between the respective display modes is irreversible, table calculation data that can be generated using free-of-charge software is limited to a standard mode. Accordingly, when layout information is extracted from table calculation data that is generated in a layout mode and a PDF is generated from the extracted layout information, the unintended margin 1600 is formed.

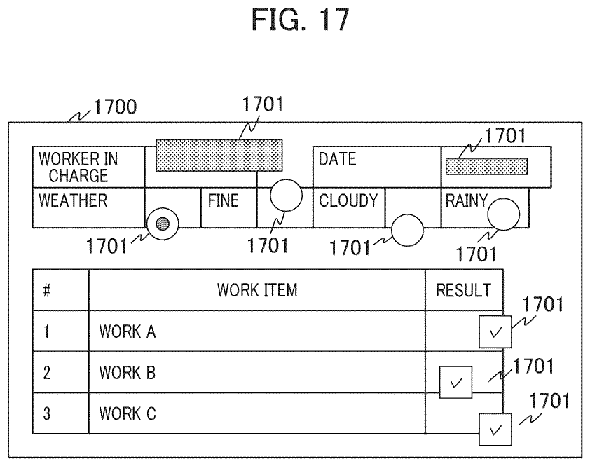

FIG. 17 illustrates an example of a PDF where the displacement occurs with respect to the size and the position of a form. When an input form 1701 is generated in a check sheet 1700 obtained by the conversion of table calculation data into the PDF, the displacement occurs in size and in position. It is considered that the displacement in position is caused by a fact that the coordinate systems on a screen and the coordinate systems on a PDF in table calculation software differ from each other. On the other hand, it is considered that the displacement in size is caused by a fact that the size of a cell does not linearly respond to a printing magnification that indicates a scale of a layout of table calculation data.

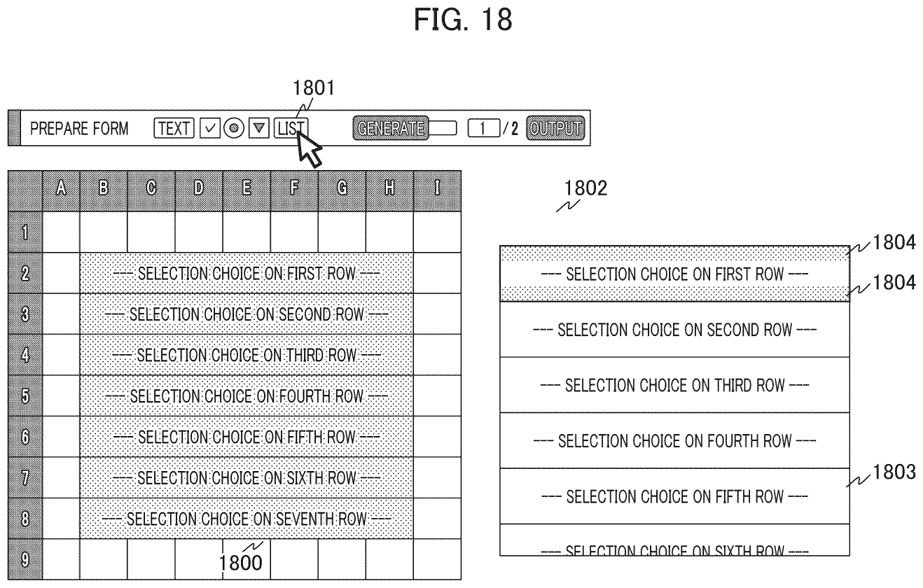

FIG. 18 illustrates an example of a case where characters in a form are cut off so that the characters cannot be seen. A case is considered where a user selects cells 1800 within seven rows in total, and then, generates a check sheet 1802 with a list having seven items in total by clicking a list generation icon 1801. Although a list 1803 having seven items is generated in the check sheet 1802 with a list, the choices in the sixth row and in the seventh row are cut off so that these choices cannot be seen. The reason that the choices are cut off is that a margin 1804 is generated above and below each choice.

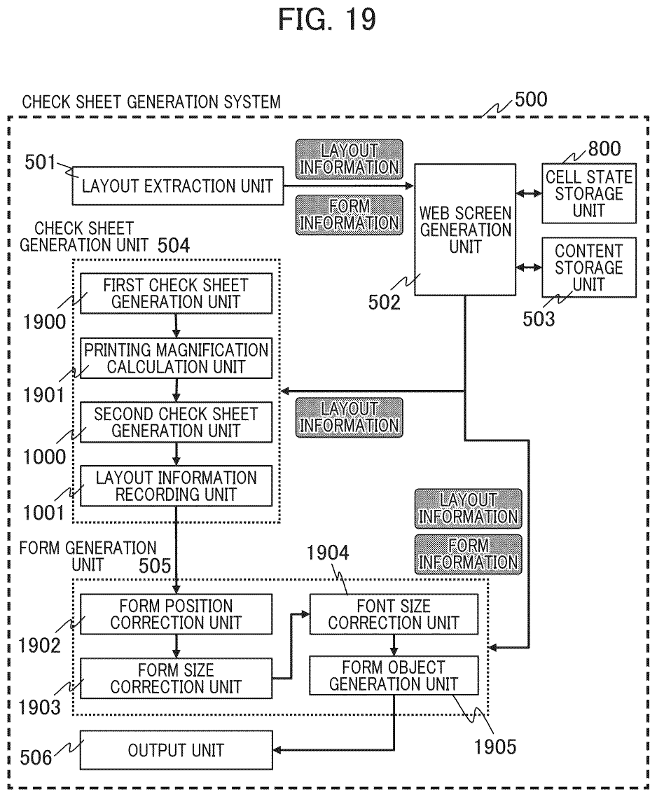

FIG. 19 is a configurational view of the check sheet generation system 500 according to the sixth embodiment. The check sheet generation system 500 according to the sixth embodiment partially differs with respect to the configuration of the check sheet generation unit 504 and the form generation unit 505 among the configurations described in the above-mentioned embodiments. The check sheet generation unit 504 includes, in addition to the configurations described in the above-mentioned embodiments, a first check sheet generation unit 1900, and a printing magnification calculation unit 1901. The form generation unit 505 includes, in addition to the function for generating a form (form object generation unit 1905) described in the above-mentioned embodiments, a form position correction unit 1902, a form size correction unit 1903, and a font size correction unit 1904.

The first check sheet generation unit 1900 generates a first check sheet based on layout information that the content storage unit 503 stores. The printing magnification calculation unit 1901 generates a second check sheet with a special marker by providing the special marker to the first check sheet that is generated, and calculates a printing magnification (used as an enlargement and reduction magnification) that suppresses an unintended margin based on positional coordinates of the special marker. The form position correction unit 1902 provides a special character to the generated first check sheet, sets the calculated printing magnification to the first check sheet with the special character and converts the first check sheet into a second check sheet with the special character, and obtains the correct position of the form by detecting the positional coordinates of the special character. The form size correction unit 1903 calculates the correct sizes of the form by using respective correction tables for correcting the height and the width of the form relating to the printing magnification. The font size correction unit 1904 calculates the font size of the form by using a correction table for correcting the font size of the form relating to the size and the number of rows in the form. The specific methods relating to these corrections are described later.

In the sixth embodiment, the description is made with respect to the method of converting the first check sheet that is generated based on the layout information into the second check sheet with a form. Layout information and form information are recorded in the second check sheet generated in the sixth embodiment. Accordingly, by generating a web screen for form information registration using these information, it is possible to resume the registration of form information from the middle. However, the web screen is not with a means to compile the layout information. When the first check sheet that is an original is compiled for layout compilation, since the form information is not registered in the first check sheet that is the original, it is necessary to register the form information from the beginning on the web screen. To eliminate such time and efforts, it is possible to provide a user interface that can compile a layout on a web screen. However, there is a strong need for the compilation of a layout of a check sheet using table calculation software that a user is used to use. In view of such circumstances, the check sheet generation system 500 according to the sixth embodiment records form information stored in the content storage unit 503 with respect to inner data of the first check sheet in a first data format generated by a first check sheet generation unit 1900, and outputs the first check sheet with the output unit 506. By enabling a user to select an output format of the check sheet on a web screen for form information registration, even when the user compiles a layout using table calculation software that the user is used to use, the user can resume the registration of the form information from the middle.

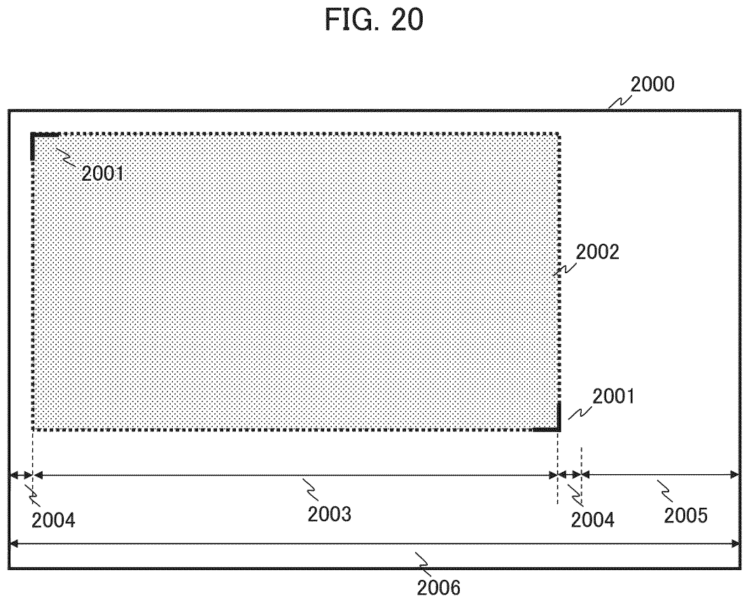

FIG. 20 is a view illustrating a method of calculating a printing magnification for suppressing an unintended margin. The printing magnification calculation unit 1901 generates a PDF 2000 with a special marker where the special marker is provided to an edge portion of a printing range on a first check sheet generated by the first check sheet generation unit 1900. A special marker 2001 is provided to the PDF 2000 with a special marker. A region 2002 surrounded by the special marker 2001 is a region of the check sheet. Assuming a case where a uniform margin 2004 exists on the left and the right of a width 2003 of the check sheet, an unintended margin is a width 2005. The printing magnification that suppresses the unintended margin 2004 can be calculated using a total width 2006 of the PDF by Formula 1.

$$printing magnification = ( total width - margin * 2 ) / width of check sheet \qquad Formula 1$$

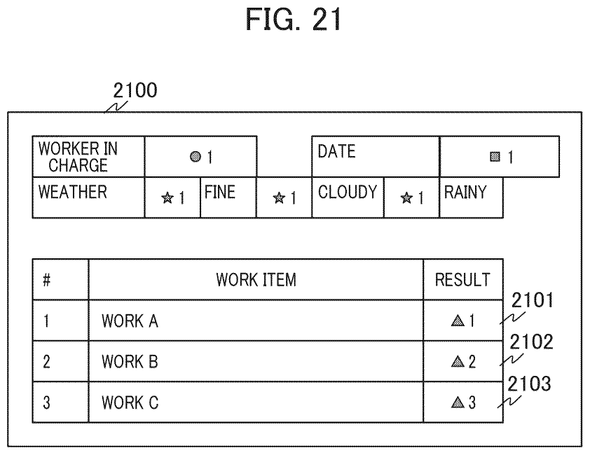

FIG. 21 is an example of a PDF with special characters. The form position correction unit 1902 generates a PDF 2100 with special characters and, thereafter, detects the positions of the special characters, and records the positions as origins of the positions of the corresponding forms. A circle, a quadrangle, a star and a triangle in FIG. 21 are respectively special characters. With respect to special characters that are of the same kind but are detected at positions in the different form, identification numbers are further provided. For example, the special characters 2101, 2102 and 2103 are detected as the positions of respectively different check boxes.

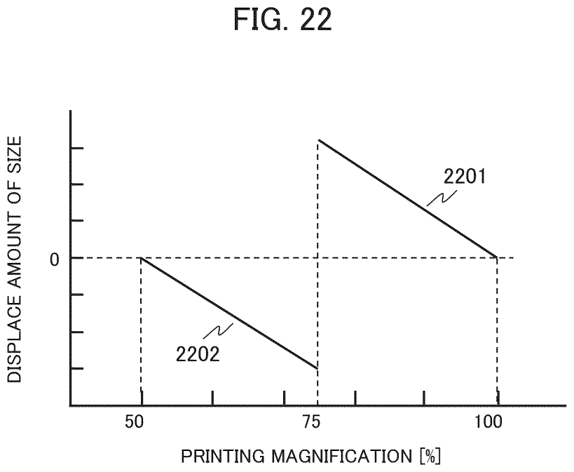

FIG. 22 is a view illustrating the relationship between a printing magnification and a displacement amount of a size. As illustrated in FIG. 22, when the printing magnification is changed, the displacement occurs with respect to the size of a form generated on a PDF. This displacement amount of the size has a first characteristic 2201 and a second characteristic 2202 using a printing magnification of 75% as a boundary. Accordingly, in this embodiment, two kinds of correction tables that correct the size of the form corresponding to the printing magnification are generated in advance, and a form size correction unit 1903 sets the size of the form such that the size displacement is suppressed in accordance with the correction table of the form size correction unit 1903 These correction table data may be stored in advance in the storage unit that the check sheet generation system 500 includes, or may be obtained from an external device via network or the like.

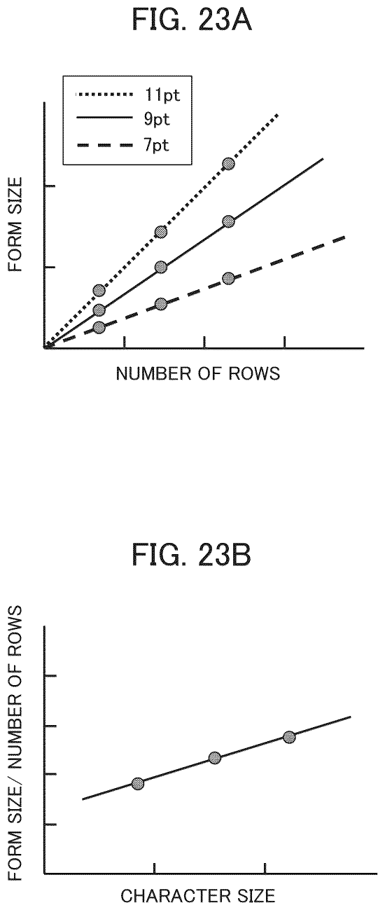

FIG. 23A is a view illustrating the relationship between the number of rows and a form size. FIG. 23A illustrates the relationship between the number of rows and the form size at the character sizes 7 pt, 9 pt and 11 pt. In all character sizes, the number of rows and the form size indicate a linear response.

FIG. 23B is a view where the relationship between the character size and the form size per a unit row is plotted based on the characteristics in FIG. 23A. The character size and the form size per unit row indicates a linear response. This response characteristic is expressed by Formula 2 using constants A, B. The form size can be expressed by Formula 3 by modifying Formula 2. The form size expressed by Formula 3 is calculated based on a gradient of the response characteristic indicating the relationship between the number of rows and the form size, and an intercept is not taken into account. The form size is expressed by Formula 4 by adding a constant C that reduces an error included in Formula 3. By modifying this Formula 4, an optimum character size can be calculated by Formula 5.

$$form size / number of rows = A * character size + B \qquad Formula 2$$

$$form size = ( A * character size + B ) * number of rows \qquad Formula 3$$

$$form size = ( A * character size + B ) * number of rows + C \qquad Formula 4$$

$$character size = \{ ( form size - C ) / number of rows - B \} / A \qquad Formula 5$$

In this embodiment, a correction table that corrects the font size of the form in response to the form size and the number of rows is generated in advance, and the font size correction unit 1904 sets the character size in accordance with the correction table. These correction table data may be stored in advance in the storage unit that the check sheet generation system 500 includes, or may be obtained from an external device via network or the like.

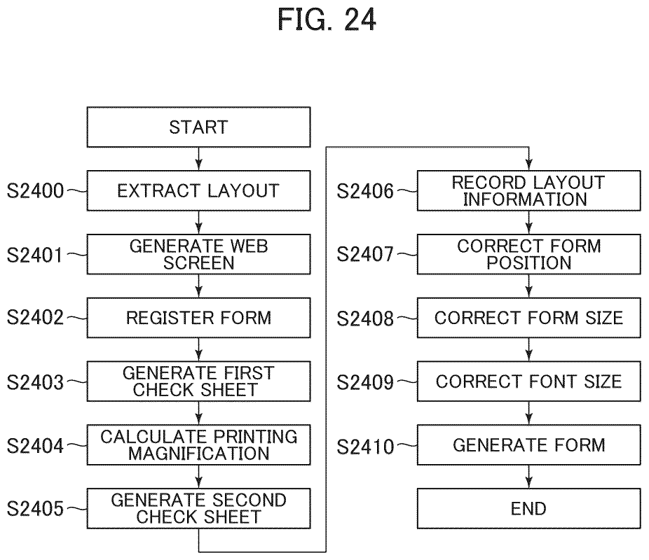

FIG. 24 is a flowchart describing an operation of the check sheet generation system 500 according to the embodiment 6. Layout information such as cell sizes, coupled cells, ruled lines and characters are extracted from the first check sheet, or the layout information and form information are extracted from the second check sheet (S2400). Next, the web screen for form information registration that has the cell region partitioned in a grid form based on the extracted layout information is generated (S2401). The form information of respective cells are registered on the web screen (S2402). Next, the first check sheet is generated based on the layout information (S2403), a PDF with special markers is generated by providing the special markers to the generated first check sheet, and the printing magnification that suppresses an unintended margin is calculated based on the positions of the special markers (S2404). Next, the first check sheet is converted into the PDF based on the calculated printing magnification (S2405), and the layout information is recorded in the generated PDF (S2406). Next, the PDF with special characters where the special characters are provided to the first check sheet is generated, and the positions of the forms corresponding to the special characters are obtained based on the positions of the special characters (S2407). Next, the correct form size where the size displacement is suppressed is obtained by using two kinds of correction tables that correct the size of the form corresponding to the printing magnification (S2408). Next, the optimum character size of the form is obtained by using the correction table that corrects the font size of the form corresponding to the form size and the number of rows (S2409). The form is generated on the PDF by using the correction information in S2407 to S2409 (S2410).

### SIXTH EMBODIMENT: SUMMARY

The check sheet generation system 500 according to the sixth embodiment converts the first check sheet where the special markers are provided to the edge portion of the printing region into the second check sheet, and calculates the printing magnification that suppresses an unintended margin based on the position coordinates of the special markers on the second check sheet. Further, to the first check sheet to which special characters are provided at positions where a user wants to dispose the forms, the printing magnification that suppresses an unintended margin is set thus converting the first check sheet to the second check sheet, and the positional coordinates of the special characters on the second check sheet are obtained as position coordinates of the forms corresponding to the special characters. Further, the form size is obtained by using two kinds of correction tables that correct the form size corresponding to the printing magnification. Further, the font size of the form is obtained by using the correction table that corrects the font size of the form corresponding to the form size and the number of rows. The form is generated on the second check sheet based on the information on the position and the size of the form and the font size obtained in the manner described above. After the data format is converted, the form is provided to the converted data form. Accordingly, the displacement of the position and the size of the form which may be caused by the conversion can be avoided. Further, the check sheet generation system 500 is configured to be capable of outputting the first check sheet on which the form information is recorded and hence, a user can compile a layout on the table calculation software that the user is used to use whereby the registration of the form information on the web screen can be resumed from the middle.

### MODIFICATION OF PRESENT INVENTION

The present invention is not limited to the embodiments described heretofore, and includes various modifications. For example, the above-mentioned embodiments are described in detail for describing the present invention in an easily understandable manner and hence, it is not always the case that the check sheet generation system is limited to the check sheet generation system that includes the whole constitutional elements described in any embodiments. Some of the constitutional elements of one embodiment can be replaced with constitutional elements of other embodiment. Further, it is also possible to add constitutional elements of the other embodiment to the constitutional elements of one embodiment. Further, with respect to some of constitutional elements of each embodiment, other constitutional elements can be added, deleted or replaced.

In the embodiments described heretofore, the respective functional units that the check sheet generation system 500 includes may be constituted by hardware such as a circuit device on which these functions are implemented. Further, the respective functional parts that the check sheet generation system 500 includes can be constituted by allowing a processor to execute software in which these functions are implemented. The content storage unit 503 that stores the layout information and the form information may be provided on the check sheet generation system 500. Alternatively, such the content storage unit 503 may be constituted as a storage unit that an external device includes, and the check sheet generation system 500 may get access to the storage unit via a network.

In the above-mentioned embodiment, in the check sheet generation unit, based on the form information and the layout information that the second check sheet has, the first check sheet that reflects these information may be generated. By outputting the first check sheet from the output unit 506, the check sheet can be recompiled on the table calculation sheet. For example, a case is considered where, after the input form compiled on the web screen is disposed in PDF data (second check sheet), and, thereafter, it is necessary to recompile the input form. In this case, it is necessary to perform the recompilation on the web screen or on the table calculation sheet. However, the content compiled on the web screen does not exist in the first check sheet. This is a reason why the compilation is performed only on the web screen. In view of the above, by acquiring attributes of the input form after the compilation from the second check sheet and by reflecting the attributes to the first check sheet, the recompilation can be performed on the table calculation sheet. Accordingly, the check sheet generation system 500 is convenient for a user who are used to handle the table calculation sheet.

In the above-mentioned embodiments, the description has been made with respect to the case where the input form that the table calculation sheet includes is reflected on the PDF data. It must be noted that the present invention is also applicable to an input form that includes other table format data. For example, also with respect to a table in a document that document generation software generates, attributes of the input form are compiled on the web screen by converting the input form into a web form in the same manner as the present invention, and a result of the compilation can be reflected on the PDF data.

What is claimed is:

1. A check sheet generation system comprising:
a layout extraction unit configured to extract layout information including information on a cell size, coupled cells, ruled lines and characters from a first check sheet in a table calculation table format generated in a first data format;
a web screen generation unit configured to generate a web screen having a cell region partitioned in a grid shape based on the layout information;
a content storage unit configured to store the layout information, and form information that describes attributes of an input form set with respect to cells that the cell region has;
a check sheet generation unit configured to generate a second check sheet in a second data format based on the layout information that the content storage unit stores;
a form generation unit configured to generate an input form in the second check sheet based on the layout information that the content storage unit stores and the form information that the content storage unit stores: and
an output unit configured to output the second check sheet to which the form generation unit provides a form, wherein
the web screen is configured to display a web check sheet that includes the input form, and
the form generation unit is configured to, in a case where an attribute of the input form is newly provided to the web check sheet on the web screen, generate the second check sheet that reflects an input form having the newly provided attribute.

2. The check sheet generation system according to claim 1, wherein
the web screen includes a form kind designation unit having a kind designation icon that designates a kind of an input form that is generated with respect to the selected cell,
the web screen generation unit is configured to generate an input form that corresponds to the kind designation icon designated by the form kind designation unit with respect to the selected cell in the web check sheet, and
the web screen generation unit is configured to display an icon indicating a kind of an input form generated with respect to the selected cell in the selected cell.

3. The check sheet generation system according to claim 2, wherein
the web screen is configured such that the cell in the cell region is configured to be capable of changing over an item to be displayed between an icon corresponding to a kind of a form designated by the form kind designation unit and a component into which information can be inputted.

4. The check sheet generation system according to claim 1, further comprising
a cell state storage unit that configured to store a state of a software component on which the respective cells in the cell region are implemented, wherein
the web screen generation unit is configured, when the web screen is updated, to compare states of the respective cells in the cell region and a state of the software component that the cell state storage unit stores to each other thus redrawing only the cells that change from the stored state.

5. The check sheet generation system according to claim 1, further comprising
a layout information recording unit configured to record the layout information that the content storage unit stores on the second check sheet, wherein
the layout extraction unit is configured to extract the layout information and the form information from the second check sheet that records the layout information.

6. The check sheet generation system according to claim 2, wherein
the form kind designation unit has a format designation icon that designates a data format that is inputted to a generated input form to any one of date, time and a numerical value, and
the form generation unit is configured to generate an input form that receives only a data format designated by the format designation icon.

7. The check sheet generation system according to claim 2, wherein
the form kind designation unit includes at least one of:
the kind designation icon that performs designation such that a hand-written character input form for filling with a hand-written character is generated;
the kind designation icon that performs designation such that a hand-written numerical value input form for filling with a hand-written numerical value is generated;
the kind designation icon that performs designation such that a predetermined calculation is implemented and a cell that displays a result of the predetermined calculation is generated; and
the kind designation icon that performs designation such that a predetermined determination arithmetic operation is implemented and a cell that displays a result of the predetermined determination arithmetic operation is generated.

8. The check sheet generation system according to claim 2, wherein
the web screen has an attribute setting screen into which attributes of the input form are inputted, and
the form generation unit is configured to reflect the attributes that are inputted into the attribute setting screen as attributes of an input form that the second check sheet has.

9. The check sheet generation system according to claim 1, further comprising
a first check sheet generation unit configured to generate the first check sheet based on the layout information, wherein
the check sheet generation unit is configured to generate the second check sheet by conversion of the first check sheet that the first check sheet generation unit generates.

10. The check sheet generation system according to claim 9, further comprising
a printing magnification calculation unit configured to calculate an enlargement and reduction magnification that is capable of suppressing a margin of the second check sheet by generating the second check sheet with a special marker to an edge portion of a printing region of the first check sheet, and by detecting position coordinates of the special marker and a page size from the second check sheet with the special marker, wherein
the check sheet generation unit is configured to convert the first check sheet into the second check sheet after the enlargement and reduction magnification that the printing magnification calculation unit calculates is set with respect to the first check sheet.

11. The check sheet generation system according to claim 9, further comprising
a form position correction unit configured to calculate an origin of the input form by converting the first check sheet with a special character corresponding to a kind of the input form into the second check sheet, and by detecting a position of the special character from the second check sheet with the special character, wherein
the form generation unit is configured to generate an input form in the second check sheet using the origin that the form position correction unit has calculated as a reference position.

12. The check sheet generation system according to claim 10, further comprising
a form size correction unit configured to correct a size displacement of an input form on the second check sheet using: a first form size correction table configured to correct a size displacement of the input form on the second check sheet when the enlargement and reduction magnification falls within a first range, and a second form size correction table configured to correct the size displacement of the input form on the second check sheet when the enlargement and reduction magnification falls within a second range that differs from the first range.

13. The check sheet generation system according to claim 1, further comprising
a font size correction unit configured to set a character size of an input form on the second check sheet by using a font size correction table that describes a relationship between a size of the input form, a number of rows that the input form has, and an appropriate character size that the input form displays.

14. The check sheet generation system according to claim 9, wherein
the first check sheet generation unit is configured to generate the first check sheet having the form information and the layout information based on the form information and the layout information that the second check sheet has, and
the output unit is configured to output the first check sheet having the layout information and the form information that the first check sheet generation unit has generated.
